(19) United States
(12) Patent Application Publication
(10) Pub. No.: US 2024/0378790 A1
(43) Pub. Date: Nov. 14, 2024

(54) PIPELINED GRAPHICS STATE MANAGEMENT

(71) Applicant: ADVANCED MICRO DEVICES, INC., Santa Clara, CA (US)

(72) Inventors: Alexander Fuad Ashkar, Winter Park, FL (US); Manu Rastogi, Casselberry, FL (US); Nishank Pathak, Orlando, FL (US); Harry J. Wise, Orlando, FL (US)

(21) Appl. No.: 18/374,736

(22) Filed: Sep. 29, 2023

Related U.S. Application Data
(60) Provisional application No. 63/464,974, filed on May 9, 2023.

(51) Int. Cl. G06T 15/00

(52) U.S. Cl. CPC G06T 15/005

(57) ABSTRACT

A processor includes a plurality of state registers and a command processor. The plurality of state registers is configured to maintain context states for a plurality of graphics contexts. The command processor includes a processing unit and a fixed-function hardware circuit. The processing unit is configured to place a plurality of graphics commands into a queue. The fixed-function hardware circuit is configured to monitor a graphics command stream output by the queue and detect a specified graphics command in the monitored graphics command stream. In response to the detected specified graphics command, the fixed-function hardware circuit is further configured to perform at least one graphics command management operation that includes one or more of a graphics context management operation or a graphics persistent state management operation.

### BACKGROUND

A graphics processing unit (GPU) is a processing unit that is specially designed to perform graphics processing tasks. A GPU may, for example, execute graphics processing tasks required by an end-user application, such as a video game application. Typically, there are several layers of software between the end-user application and the GPU. For example, in some cases, the end-user application communicates with the GPU via an application programming interface (API). The API allows the end-user application to output graphics data and commands in a standardized format rather than in a format that is dependent on the GPU.

Many GPUs include graphics pipelines for executing instructions of graphics applications. A graphics pipeline includes a plurality of processing blocks that work on different steps of an instruction at the same time. Pipelining enables a GPU to take advantage of parallelism that exists among the steps needed to execute the instruction. As a result, a GPU can execute more instructions in a shorter period of time. The output of the graphics pipeline is dependent on the state of the graphics pipeline. The state of a graphics pipeline is updated based on state packages (e.g., context-specific constants including texture handlers, shader constants, transform matrices, and the like) that are locally stored by the graphics pipeline. Because the context-specific constants are locally maintained, they can be quickly accessed by the graphics pipeline.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example processing system in accordance with some implementations.

FIG. 2 is a block diagram of a pipelined state management circuit implemented by the processing system of FIG. 1 in accordance with some implementations.

FIG. 3 is a block diagram of the processing system of FIG. 1 processing command stream instructions at a graphics processing unit in accordance with some implementations.

FIG. 4, FIG. 5, FIG. 6, FIG. 7, FIG. 8, and FIG. 9 together are a flow diagram illustrating an example method for performing pipelined graphics state management in accordance with at least some implementations.

FIG. 10 is a block diagram illustrating another configuration of the pipelined state management circuit implemented by the processing system of FIG. 1 in accordance with some implementations.

FIG. 11 illustrates an example of a graphics context hash table in accordance with some implementations.

FIG. 12 is a block diagram illustrating a further configuration of the pipelined state management circuit implemented by the processing system of FIG. 1 in accordance with some implementations.

FIG. 13 illustrates an example of a graphics context reuse table in accordance with some implementations.

FIG. 14 and FIG. 15 together are a flow diagram illustrating an example method for performing a graphics context reuse in accordance with at least some implementations.

FIG. 16 is a block diagram illustrating context reuse logic in the pipelined state management circuit of FIG. 1 performing a row selection process and a column selection process as part of the method in FIG. 14 and FIG. 15 in accordance with some implementations.

FIG. 17 and FIG. 18 are block diagrams illustrating context reuse logic in the pipelined state management circuit of FIG. 1 performing context reuse check operations in accordance with some implementations.

### DETAILED DESCRIPTION

To perform graphics processing, a central processing unit (CPU) of a system often issues to a GPU a call, such as a draw call, which includes a series of commands instructing the GPU to draw an object according to the CPU's instructions. As the draw call is processed through the GPU graphics pipeline, the draw call uses various configurable settings to decide how meshes and textures are rendered. A common GPU workflow involves updating the values of constants in a memory array and then performing a draw operation using the constants as data. A GPU whose memory array includes a given set of constants may be considered to be in a particular state. These constants and settings, referred to as context state (also referred to as “rendering state”, “GPU state”, or simply “state”), affect various aspects of rendering and include information the GPU needs to render an object. The context state provides a definition of how meshes are rendered and includes information such as the current vertex/index buffers, the current vertex/pixel shader programs, shader inputs, texture, material, lighting, transparency, and the like. The context state includes information unique to the draw or set of draws being rendered at the graphics pipeline. Context, therefore, refers to the required GPU pipeline state to draw something correctly.

Many GPUs use a technique known as pipelining to execute instructions. Pipelining enables a GPU to work on different steps of an instruction at the same time, thereby taking advantage of parallelism that exists among the steps needed to execute the instruction. As a result, the GPU can execute more instructions in a shorter period of time. The video data output by the graphics pipeline is dependent on state packages (e.g., context-specific constants) that are locally stored by the graphics pipeline. In GPUs, it is common to set up the state of the GPU, perform a draw operation, and then make only a small number of changes to the state before the next draw operation. The state settings (e.g., values of constants in memory) often remain the same from one draw operation to the next.

The context-specific constants are locally maintained for quick access by the graphics pipeline. However, GPU hardware is generally memory constrained and only locally stores (and therefore operates on) a limited number of sets of context state. Accordingly, the GPU will often change the context state in order to start working on a new set of context registers because the graphics pipeline state needs to be changed to draw something else. The GPU performs a context roll to a newly supplied context to release the current context by copying the current registers into a newly allocated context before applying any new state updates by programming fresh register values. Due to the limited number of context state sets stored locally, the GPU sometimes runs out of context, and the graphics pipeline is stalled while waiting for a context to be freed so that a new context may be allocated. These stalls create a barrier in the GPU that prevent the GPU from continuing to work ahead with issuing draw packets and state updates.

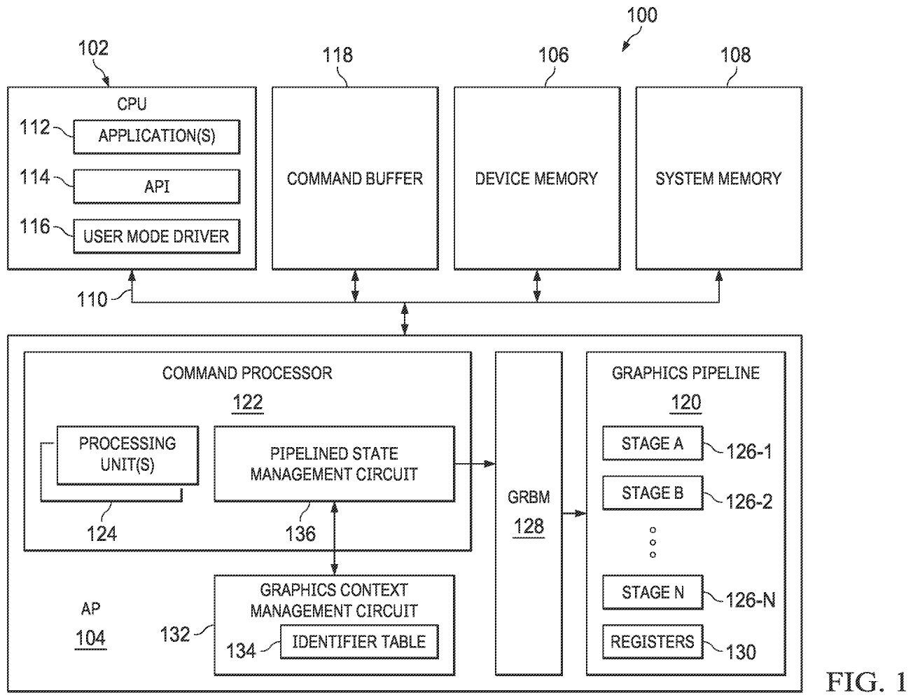

To improve GPU system performance, FIGS. 1-18 illustrate systems and methods implementing pipelined state management techniques that enable the GPU to continue working ahead (e.g., issue draw packets and state updates) even though a context is not currently available. Stated differently, the component(s) of the GPU, such as a command processor, responsible for issuing draw packets, state updates, and the like is not stalled while waiting for a context to be freed. As described below, a graphics register queue is implemented between the command processor and the component(s) of the GPU that controls and manages access to various registers in the GPU, such as a graphics register bus manager (GRBM). The command processor pipelines requests associated with draw packets and state update packets into the graphics register queue in a context-agnostic manner. For example, when a context is not available to satisfy a context roll request, the command processor continues to work forward by placing draw packets and state update packets in the graphics register queue instead of stalling.

As such, the command processor is no longer required to track the state transitions between draw packets and context state update packets, allocate contexts, or insert events, such as Block Context Done events or Context Done events, into the stream of commands between the graphics register queue and the GRBM. Instead, these state and context management processes are performed by a hardware component, such as a command processor barrier and state manager (CP_BSM), implemented between the graphics register queue and the GRBM. The CP_BSM continually snoops the output command stream of the graphics register queue for specific commands, such as barrier register writes, to manage state transitions, context allocation, and the issuance of Context Done and Block Context Done events. For example, the CP_BSM monitors the output command stream to determine when a context needs to be allocated, when a context roll needs to be performed, when a context is not available and the commands being sent to the GRBM should be paused or held, when Context Done and Block Context Done events should be inserted into the command stream, and the like. In at least some implementations, a Context Done event refers to an indication (e.g., a message, a notification, a signal, or the like) that is associated with a corresponding identifier that is sent from the CP_BSM to the graphics pipeline to act as a marker for the components in the graphics pipeline, indicating that the context is going to change after the current draw operation. When the components in the graphics pipeline complete their processing for the current draw operation, these components send an indication back to the CP_BSM (or a context manager) indicating they have completed processing the current draw command. In at least some implementations, the components send the indication along with the corresponding identifier of the Context Done event. A Block Context Done event, in at least some implementations, is used by the components in the graphics pipeline to associate pipeline state changes between draws.

By moving the state and context management responsibilities from the command processor to the CP_BSM, the command processor becomes “context unaware,” and processes draw call packets and state update packets independent of context. Since the command processor no longer considers context, and pipelines these packets in the graphics register queue, the overhead and stalls typically experienced by the command processor when previously managing state and context are eliminated or at least reduced. Therefore, the command processor gains additional processing cycles, which increases the throughput of the GPU and allows for draw calls to be issued at a higher rate.

FIG. 1 is a block diagram illustrating a processing system 100, including a graphics processing unit configured to implement pipeline state management in accordance with some implementations. In the depicted example, the processing system 100 includes a central processing unit (CPU) 102, a graphics processing unit (GPU) 104, a device memory 106 utilized by the GPU 104, and a system memory 108 shared by the CPU 102 and the GPU 104. The GPU 104, in at least some implementations, is a dedicated device, several devices, or integrated into a larger device. In at least some implementations, the GPU 104 is implemented as part of an accelerated processing device (APD) that accepts both compute commands and graphics rendering commands from the CPU 102. The APD includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. The APD and the CPU 102, in at least some implementations, are formed and combined on a single silicon die or package to provide a unified programming and execution environment. In other implementations, the APD and the CPU 102 are formed separately and mounted on the same or different substrates.

The memories 106, 108 include any of a variety of random access memories (RAMs) or combinations thereof, such as a double-data-rate dynamic random access memory (DDR DRAM), a graphics DDR DRAM (GDDR DRAM), and the like. The GPU 104 communicates with the CPU 102, the device memory 106, and the system memory 108 via a bus 110. The bus 110 includes any type of bus used in computing systems, including, but not limited to, a peripheral component interface (PCI) bus, an accelerated graphics port (AGP) bus, a PCI Express (PCIE) bus, and the like.

The CPU 102 sends instructions intended for processing at the GPU 104 to command buffers. In at least some implementations, the command buffers are located, for example, in system memory 108 in a separate memory coupled to the bus 110 (e.g., device memory 106).

As illustrated, the CPU 102 includes a number of processes, such as executing one or more application(s) 112 to generate graphic commands and a user mode driver 116 (or other drivers, such as a kernel mode driver). In at least some implementations, the one or more applications 112 include applications that utilize the functionality of GPU 104. An application 112 may include one or more graphics instructions that instruct GPU 104 to render a graphical user interface (GUI) and/or a graphics scene. For example, the graphics instructions may include instructions that define a set of one or more graphics primitives to be rendered by GPU 104.

In at least some implementations, the application 112 utilizes a graphics application programming interface (API) 114 to invoke a user mode driver 116 (or a similar GPU driver). The user mode driver 116 issues one or more commands to GPU 104 for rendering one or more graphics primitives into displayable graphics images. Based on the graphics instructions issued by the application 112 to the user mode driver 116, the user mode driver 116 formulates one or more graphics commands that specify one or more operations for GPU 104 to perform for rendering graphics. In at least some implementations, the user mode driver 116 is a part of the application 112 running on the CPU 102. In one example, the user mode driver 116 is part of a gaming application running on the CPU 102. Similarly, a kernel mode driver (not shown) may be part of an operating system running on the CPU 102. The graphics commands generated by the user mode driver 116 include graphics commands intended to generate an image or a frame for display. The user mode driver 116 translates standard code received from the API 114 into a native format of instructions understood by the GPU 104. The user-mode driver 116 is typically written by the manufacturer of the GPU 104. Graphics commands generated by the user mode driver 116 are sent to GPU 104 for execution. The GPU 104 executes the graphics commands and uses the results to control what is displayed on a display screen.

In at least some implementations, the CPU 102 sends graphics commands intended for the GPU 104 to a command buffer 118. Although depicted in FIG. 1 as a separate component for ease of illustration, the command buffer 118, in at least some implementations, is located in device memory 106, system memory 108, or a separate memory coupled to the bus 110. The command buffer 118 temporarily stores a stream of graphics commands that include input to the GPU 104. The stream of graphics commands includes, for example, one or more command packets and/or one or more state update packets. In some implementations, a command packet includes a draw command (also referred to herein as a “draw call”) instructing the GPU 104 to execute processes on image data to be output for display. For example, a draw command may instruct the GPU 104 to render an object defined by a group of one or more vertices (e.g., defined in a vertex buffer) stored in memory. The geometry defined by the group of one or more vertices corresponds, in some implementations, to a plurality of primitives to be rendered.

In at least some implementations, a state command (also referred to herein as a “state update packet”) instructs the GPU 104 to change one or more context state variables (e.g., a draw color) or persistent state variables (e.g., shader program settings). In one example, a state update packet is a context state update packet (also referred to herein as a “context update packet), which is a type of command packet that includes a constant or a set of constants that updates the state of graphics pipeline 120 at the GPU 104. A context update packet may, for example, update colors that are to be drawn or blended during execution of a draw call. In another example, a state update packet is a graphics persistent state update packet, which is a type of command packet that includes updates to the persistent (e.g., global) state data of the graphics pipeline 120. This state data persists across multiple tasks or draw calls. The persistent state data includes, for example, configuration settings and parameters that are applied broadly to the graphics pipeline 120 and that do not need to be changed frequently. These may include settings related to shader programs, the configuration of specific stages in the graphics pipeline (such as the rasterizer stage), texture sampling settings, color blending settings, and other global configurations.

The GPU 104 includes one or more processors, such as a command processor 122, that receive commands in a command stream to be executed from the CPU 102 (e.g., via the command buffer 118 and bus 110) and coordinates execution of those commands at the graphics pipeline 120. In at least some implementations, the command processor 122 is implemented as hardware, circuitry, software, firmware or a firmware-controlled microcontroller, or a combination thereof. The command stream includes one or more draw calls, state update packets, and the like, as described above. The command processor 122 also manages the context states and persistent states written to registers of the graphics pipeline 120. In at least some implementations, in response to receiving a context state update packet, the command processor 122 sets one or more state registers in the GPU 104 to particular values based on the context state update packet, configures one or more of fixed-function processing units based on the context state update packet, a combination thereof, or the like. Similarly, in response to receiving a graphics persistent state update packet, the command processor 122 sets one or more state registers in the GPU 104 to particular values or performs one or more additional operations based on the persistent state update packet.

The command processor 122, in at least some implementations, includes one or more processing units 124 that perform one or more operations of the command processor 122. Examples of the processing units 124 include a prefetch parser (PFP), micro-engines (MEs), and the like. A prefetch parser acts as a pre-processor that reads commands from the command buffer 118, decodes the command, and sends the commands to the appropriate units in the GPU 104 for execution. The prefetch parser helps in maintaining a continuous flow of commands to the GPU's execution units. The micro-engines are individual execution units within the GPU 104 that control and manage various tasks performed by other execution units of the GPU 104. For example, a micro-engine is responsible for further analyzing commands decoded by the prefetch parser and determining how the commands should be executed; dispatching the decoded commands to the appropriate units within the GPU 104 for execution, including dispatching draw commands to the shader cores, dispatching memory access commands to a memory management unit, and the like; managing the flow of commands and the context state within the GPU 104, and the like. In at least some implementations, the one or more processing units 124 are implemented as hardware, circuitry, software, firmware or a firmware-controlled microcontroller, or a combination thereof.

Although illustrated in FIG. 1 as having one command processor 122, those skilled in the art will recognize that the GPU 104 may include any number and type of command processors for retrieving and executing packets from hardware queues. In various implementations, a “packet” refers to a memory buffer encoding a single command. Different types of packets may be stored in hardware queues, memory buffers, and the like. Additionally, as used herein, the term “block” refers to a processing module (e.g., circuitry) included in an application-specific integrated circuit (ASIC), an execution pipeline of a CPU, a graphics pipeline of a GPU, a combination thereof, or the like. Such a processing module includes, but is not limited to, a cache memory, an arithmetic logic unit, a multiply/divide unit, a floating point unit, a geometry shader, a vertex shader, a pixel shader, various other shaders, a clipping unit, a z-buffer (e.g., depth buffer), a color buffer, or some other processing module.

The graphics pipeline 120 includes a number of stages 126, including stage A 126-1, stage B 126-2, and through stage N 126-N. In at least some implementations, the various stages 12 each represent a stage of the graphics pipeline 120 that execute various aspects of a draw call. The command processor 122 writes context state updates and persistent state updates to local banks of context registers and persistent state registers, respectively, for storing and updating operating state. As illustrated in FIG. 1, the command processor writes state updates to current state registers 130. In at least some implementations, the command processor 122 writes the context state updates and persistent state updates to the state registers 130 via a register bus or graphics register bus management circuit (GRBM) 128 (also referred to herein as “graphics register bus manager” 128).

In at least some implementations, the processing system 100 includes a graphics context management circuit 132 (also referred to herein as “graphics context manager 132” or “context manager 132”). The context manager 132, in at least some implementations, maintains, manages, and allocates contexts in the GPU 104. In at least some implementations, the context manager 132 includes an identifier table 134 storing a set of unique identifiers corresponding to sets of context state currently stored at registers 130 of the GPU 104. An example of an identifier table 134 includes a hash table or other data structure storing a set of hash-based or another type of identifiers. In at least some implementations, the identifiers are used by the context manager 132 to search for and identify the context states currently stored at registers 130. For example, in at least some implementations, the user mode driver 116 provides a unique hash identifier to identify a new context state that the user mode driver 116 programs into a graphics command. In at least some implementations, the user mode driver 116 indicates to the command processor 122, via a new state packet (or another token method), to scan for all active states at the GPU 104 and determine whether the unique hash identifier of the new context matches any one of the plurality of hash identifiers of currently active context states (i.e., hash identifiers stored at the identifier table 134). If the identifier table 134 does not include the requested unique hash identifier, then the context manager 132 allocates a new context using the requested unique hash identifier. However, if the identifier table 134 does include the requested unique hash identifier (thereby informing that the requested unique hash identifier corresponds to a state that is already active at the GPU 104), then the context manager 132 returns that context.

Conventional context management techniques typically configure one or more of the processing units 124 at the command processor 122 to track state transitions between draw packets and context state update packets and to manage context allocation and graphics persistent state updates. For example, a processing unit 124 is typically configured to detect draw packets, detect context state update packets when the user driver 116 changes the context state after performing a draw operation, and detect updates to the persistent state of the GPU 104. When a context state change is detected, a processing unit 124, such as an ME that writes the draw packets and state packets to the registers 130, performs a context rolling process to switch from the current context to the new context. The context rolling process typically includes requesting and waiting for a new context from the context manager 132, sending an event down the graphics pipeline to release the current context, and executing a sequence of register writes followed by a read to ensure completion of the current context once the GPU changes to a different state set. Once the current context is completed, the command processor 122 is notified and allows the context to be reused (or a new context to be allocated). However, the processing unit 124 is typically stalled during the context rolling process while waiting for the graphics pipeline to complete the operations associated with the current context so that a new context to be allocated by the context manager 132. While waiting for the new context to be allocated, the processing unit 124 does not accept or process any new commands and waits for all the tasks in the current context to be completed. As such, the processing unit 124 is prevented from continuing the processing of packets when a context is not available, which creates a barrier in the GPU 104 that prevents the GPU 104 from continuing to work ahead with issuing draw packets and state updates, thereby reducing the throughput of the GPU 104 and starving the GPU backend.

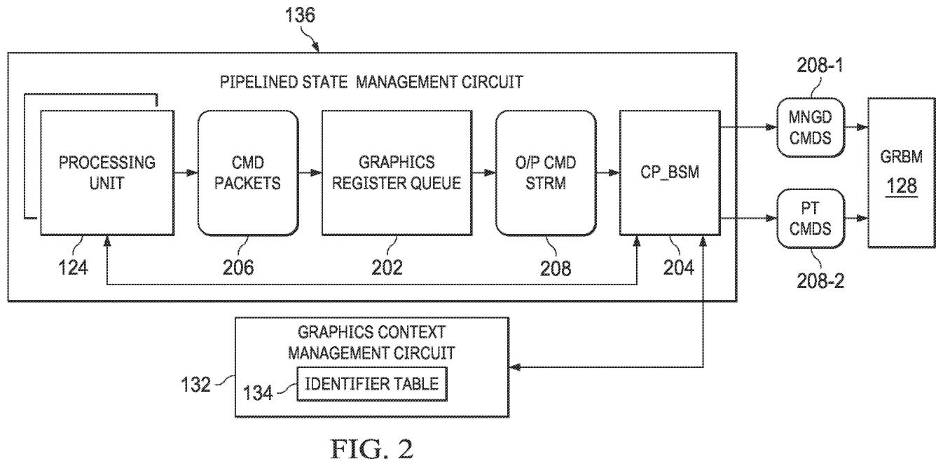

To more efficiently manage graphics context state and graphics persistent state, the GPU 104 includes a pipelined state management circuit 136 (also referred to herein as “pipelined state manager 136”). The pipelined state manager 136 enables the processing unit(s) 124 of the command processor 122 to continue processing draw call packets and state update packets even when a context is not currently available. As shown in FIG. 2, the pipelined state manager 136, in at least some implementations, includes one or more of the processing units 124 (e.g., a PFP, an ME, a combination thereof, or the like), a graphics register queue 202, a command processor barrier and state management (CP_BSM) circuit 204 (also referred to herein as “command processor barrier and state manager” 204), and the GRBM 128. However, in other implementations, the pipelined state manager 136 includes one or more additional or fewer components than those illustrated in FIG. 2. In at least some implementations, the graphics register queue 202 and the CP_BSM 204 are part of the command processor 122, whereas, in other implementations, one or more of the graphics register queue 202 or the CP_BSM 204 are separate from the command processor 122. Also, although FIG. 2 shows the context manager 132 being separate from the pipelined state manager 136, in at least some implementations, the context manager 132 is part of the pipelined state manager 136.

The processing unit(s) 124 includes, for example, an ME that processes draw call packets and state update packets. The graphics register queue 202 is a data structure in the GPU's memory that is configured to store draw commands and state update commands received from the processing unit 124. The CP_BSM 204, in at least some implementations, is fixed-function hardware (also referred to herein as a “fixed-function hardware circuit”), such as a finite state machine or other hardware or circuitry, that performs state and context management, including state transition tracking, context rolling, insertion of Context Done events or Block Context Done into the command stream, and the like. The CP_BSM 204 is disposed between the graphics register queue 202 and the graphics pipeline 120 and, more particularly, between the graphics register queue 202 and the GRBM 128. The GRBM 128 is hardware, circuitry, or a combination thereof that receives a graphics command stream 208 (also referred to herein as “command stream 208”) output by the graphics register queue 202 and controls access to registers of the GPU 104, such as the state registers 130, based on the command stream. When a context switch or roll is performed, the GRBM 128 facilitates saving the current state of the registers (as part of the current context) and loading the new state of the registers (from the new context). By managing the state of the registers, the GRBM 128 helps ensure that each task or context on the GPU has access to the correct data and resources that it needs to operate correctly.

The pipelined state manager 136 moves the responsibility of state and context management from the processing unit(s) 124 to the CP_BSM 204 so that the processing unit 124 processes draw packets and state update packets in a context-agnostic manner. For example, as the processing unit(s) 124 receives draw packets and state update packets, the processing unit(s) 124 is no longer required to track state transitions between these packets or consider context availability when processing these packets. The processing unit(s) 124 continues working forward with draw and state update packets by pipelining these packets into the graphics register queue 202 even when a context is not currently available. For example, FIG. 2 shows that the processing unit(s) 124 pipelines graphics command packets 206 (e.g., draw and state update packets) by placing the command packets 206 into the graphics register queue 202. As such, when a new context needs to be allocated when switching contexts, the processing unit(s) 124 no longer stalls and continues processing draw and state update packets.

The CP_BSM 204 takes the burden of state and context management off of the processing unit(s) 124 by performing the state and context management operations. For example, the CP_BSM 204 monitors the output command stream 208 from the graphics register queue 202 to detect specific graphics commands (e.g., register writes), such as a draw register write, a context register write, a graphics persistent state register write, or the like. When one of these commands is detected, the CP_BSM 204 performs one or more state or context management operations. For example, the CP_BSM 204 performs a context roll process or inserts a Context Done or a Block Context Done event into the command stream. The commands in the command stream 208 that are managed by the CP_BSM 204 are represented in FIG. 2 as CP_BSM managed commands 208-1. As such, any stalling during state and context management operations occurs at the CP_BSM 204 instead of the processing unit(s) 124, thereby increasing the throughput of the processing unit(s) 124. All other commands in the command stream 208 pass through the CP_BSM 204 to the GRBM 128 and are represented in FIG. 2 as pass through commands 208-2.

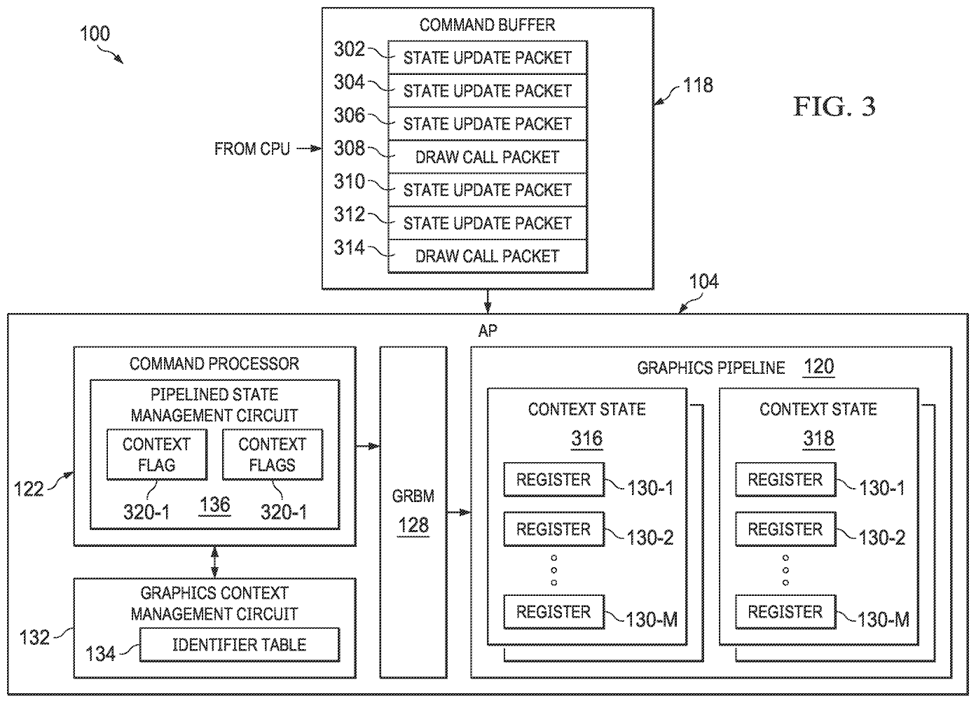

FIG. 3 is a block diagram illustrating an implementation in which the CPU 102 sends instructions intended for the GPU 104 in accordance with at least some implementations. As illustrated, the CPU 102 sends instructions to the command buffer 118. The command buffer 118 temporarily stores commands of the command stream from the CPU 102. The stream of commands includes, for example, state update packets and draw call packets. In at least some implementations, other commands are included in the stream of commands as well.

A state update packet, in at least some implementations, is a constant or a collection of constants that updates the context state or the persistent state of graphics pipeline 120. In at least some implementations, a state update packet includes a set context packet, a load context packet, a set persistent state packet, a load persistent state packet, or the like. A set context packet programs multi-context registers of the GPU 104. The set context packet includes all data required to program the state in the packet. A load context packet provides a command for fetching context information from memory before the state is written to context registers of the GPU 104. A set of persistent state packet programs multi-persistent state registers of the GPU 104. The persistent state packet includes all data required to program the state in the packet. A load persistent state packet provides a command for fetching persistent state information from memory before the persistent state is written to persistent state registers of the GPU 104. A draw call packet is a command that causes graphics pipeline 120 to execute processes on data to be output for display.

The execution of a draw call is dependent on all the context state updates that were retrieved since a previous draw call. For example, FIG. 3 illustrates seven commands that are included in the command stream: (1) a first state update packet 302, (2) a second state update packet 304, (3) a third state update packet 306, (4) a first draw call packet 308, (5) a fourth state updated packet 310, (6) a fifth state update packet 312, and (7) a second draw call packet 314. In this example, the first draw call packet 308 is dependent on the first, second, and third state update packets 302 to 306 because these are the state update packets that precede the first draw call packet 308. The second draw call packet 314 is dependent on the fourth and fifth state update packets 310 and 312 because these are the context state update packets that were received after the first draw call packet 308 and prior to the second draw call packet 214.

In at least some implementations, GPU 104 includes multiple different graphics contexts 316 and graphics persistent states 318. Each context 316 is associated with a different set of registers 130-1 to 130-M, and each persistent state 318 is associated with a different set of registers 130-3 to 130-N, which are representative of any number and type (e.g., general purpose register) of state registers and instruction pointers. The output of operations executed by the GPU 104 is dependent on the persistent state and the current context state associated with the executing operations. The current context, in at least some implementations, is based on the context state, such as values of various context-specific constants that are stored in the state registers 130 associated with the current context state. Examples of the various context-specific constants include texture handlers, shader constants, transform matrices, and the like. The values (i.e., state) of each register 130 associated with a specific context 316 are collectively referred to herein as the “state” or “context state” of the context 316.

The persistent state, in at least some implementations, is based on settings, properties, or configurations of the GPU 104 that remain constant across different tasks or operations, e.g., across context switches. Stated differently, these settings, properties, or configurations influence the rendering or computational tasks but are not tied to a specific task or context. These properties remain in effect across multiple tasks or contexts. Examples of persistent state include configuration settings related to how the geometry engine (GE) handles geometry processing or how the shader processor interpolator (SPI) performs interpolation. Additional examples of persistent state include configurations of texture units, settings or configurations of a default shader, global GPU settings, configurations of viewports and scissor tests, rasterization and depth-stencil settings, or the like.

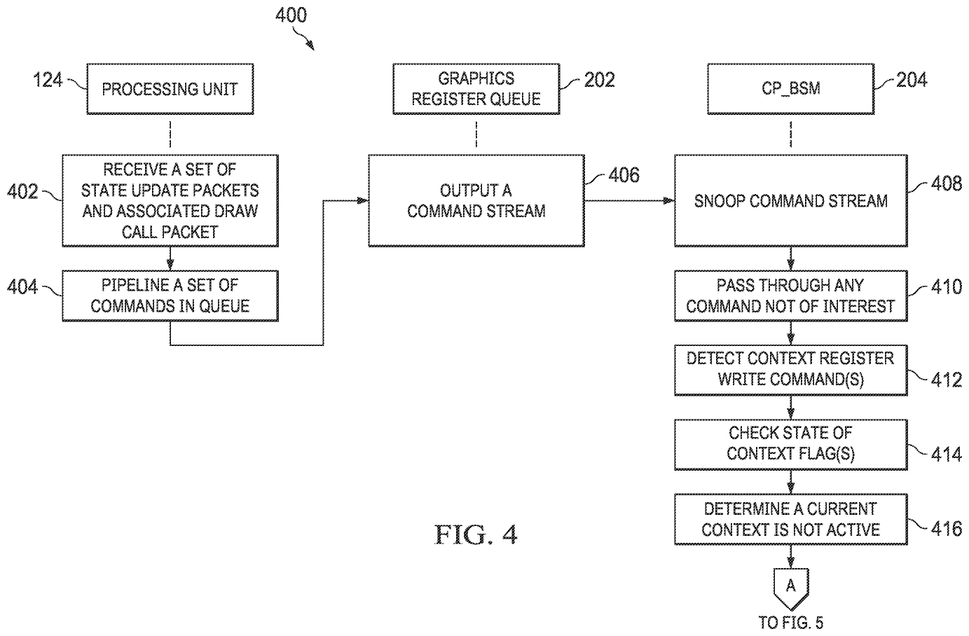

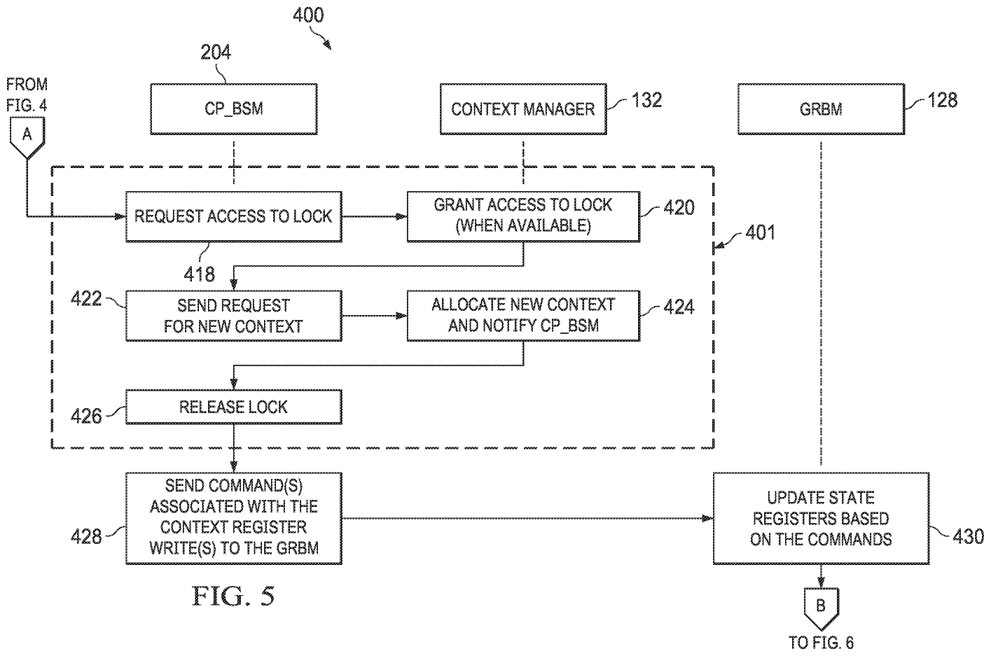

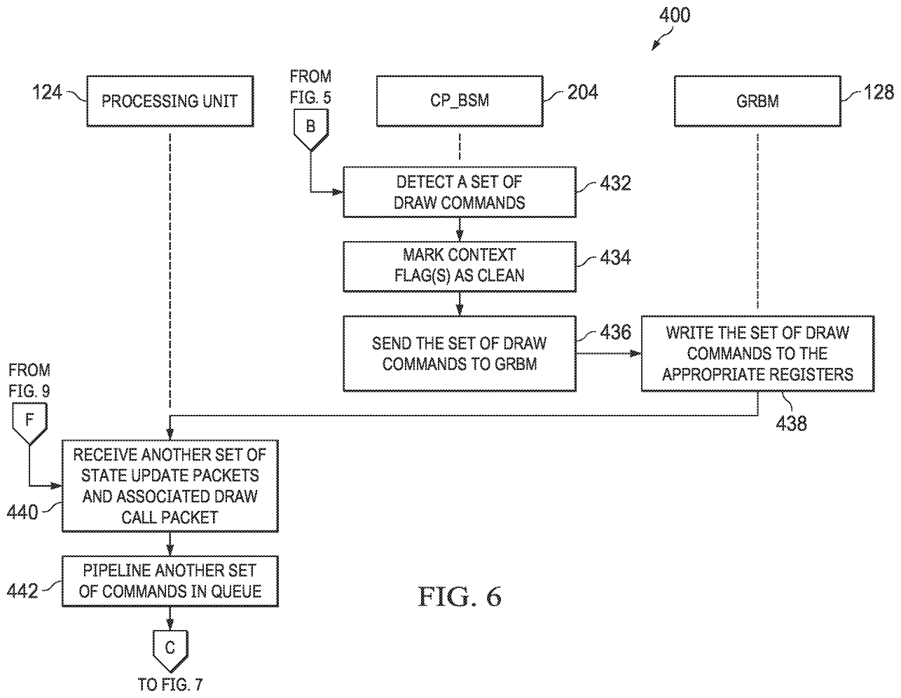

FIG. 4 to FIG. 9 are diagrams together illustrating an example method 400 of performing pipelined graphics state management in accordance with at least some implementations. For purposes of description, the method 400 is described with respect to an example implementation at the processing system 100 of FIG. 1, but it will be appreciated that, in other implementations, the method 400 is implemented at processing devices having different configurations. Also, the method 400 is not limited to the sequence of operations shown in FIG. 4 to FIG. 9, as at least some of the operations can be performed in parallel or in a different sequence. Moreover, in at least some implementations, the method 400 can include one or more different operations than those shown in FIG. 4.

At block 402, the processing unit 124 of the command processor 122 receives a set of command packets 206, including, for example, the first state update packet 302, the second state update packet 304, the third state update packet 306, and the first draw call packet 308 associated with the first set of state update packets. The processing unit 124 interprets these packets and generates commands based on their contents (e.g., corresponding register write commands, draw register writes, or persistent state register writes), which are eventually executed by the GRBM 128. At block 404, after the processing unit 124 has generated the corresponding commands, the processing unit 124 pipelines a set of commands in the graphics register queue 202. At block 406, the graphics register queue 202 outputs a command stream 208 to the GRBM 128. At block 408, the CP_BSM 204 monitors/snoops the command stream 208 to detect specific commands, such as specific register writes, that act as a barrier in the command stream 208. Examples of these commands include context register writes, draw register writes, persistent state register writes, and the like. At block 410, if the CP_BSM 204 detects a command 208-2 in the command stream 208 that is not of a command type being monitored for, the CP_BSM 204 allows the command 208-2 to pass through to the GRBM 128 for processing.

At block 412, the CP_BSM 204 detects one or more specified graphics commands. In this example, CP_BSM 204 detects a context state update command, such as a context register write command, associated with at least one of the state update packets 302 to 306. In at least some implementations, the CP_BSM 204 detects a context register write based on the register address associated with the context register write. For example, when the CP_BSM 204 detects a command in the output command stream 208, the CP_BSM 204 compares the register address included in the command to a context register aperture, which includes dedicated ranges of memory addresses that are each associated with a register 130 for a specified context 316 on the GPU 104. Stated differently, the context register aperture is associated with a specified command type (e.g., a context register write command) that writes to the registers 130 in the range of address covered by the aperture. If the register address included in the command matches a register address in the context aperture, the CP_BSM 204 determines that the command is a context register write.

At block 414, in response to detecting the context register write, the CP_BSM 204 checks the state of one or more context flags 320 (illustrated as context flag 320-1 and context flag 320-2 in FIG. 3) maintained by the CP_BSM 204. When a context flag 320 is set (e.g., has a “clean” state), this indicates that a draw operation is using (or will use) the current graphics context and graphics persistent state, and these states cannot be changed without performing an operation, such as sending either a Context Done event or a Block Context Done event down the graphics pipeline 120, to trigger the current context to finish. Stated differently, the state of the context flag(s) 320 indicates either that the current context and the current persistent state are updatable or that the current context is not updatable without issuing a Context Done event and the current persistent state 318 is not updatable without issuing a Block Context Done event. The one or more context flags 320, in at least some implementations, include a graphics context flag 320-1 and a graphics persistent state flag 320-2. In at least some implementations, when the context flags 320 are initialized, the CP_BSM 204 sets their state to “dirty”, which indicates that a draw call has not been detected and the state of the current graphics context or the graphics persistent state can be changed without issuing an event, such as a Context Done event or a Block Context Done event. However, when the CP_BSM 204 detects a draw call packet/command, the CP_BSM 204 sets the context flags 320 to the “clean” state. For example, in at least some implementations, the graphics context state and the graphics persistent state are each associated with the address space and physical storage of the state data. A dirty state flag indicates the register state data is uninitialized or being programmed for the upcoming draw command. A clean state flag indicates a draw command was initiated, and both the graphics context flag 320-1 and a graphics persistent state flag 320-2 are then clean. In at least some implementations, programming state in the graphics context or graphics persistent state register space changes the associated state flag 320 to dirty, and a clean to dirty state flag transition initiates a done event (e.g., a Context Done event or a Block Context Done event).

In the current example, the CP_BSM 204 receives the set of state update commands in the command stream 208 before a draw operation has been initiated by the GPU 104, such as after the processing system 100 is powered on or an initial boot sequence is performed. Therefore, at block 416, the CP_BSM 204 determines that the context flags 320 are set to a “dirty” state and also determines that a current context is not active (i.e., not currently being used by the GPU 104 for processing tasks). In one example, the CP_BSM 204 determines that a context is not currently allocated and active by querying the context manager 132. For example, the CP_BSM 204 sends a query to the context manager 132 requesting confirmation if there is currently an allocated context that is active (also referred to herein referred to as the “current context”). The context manager 132 sends a signal or message to the CP_BSM 204 indicating the status of an allocated and active context.

In at least some implementations, when the CP_BSM 204 detects a context register write command and a context is not currently being used by the GPU 104 for processing tasks, the CP_BSM 204 initiates a context allocation process 401 that is performed at blocks 418 to 426. The context allocation process 401, in at least some implementations, is performed to obtain an available context identifier from the context manager 142 that is to be designated as the current context for state updates and draws until the next clean to dirty state flag transition. At block 418, the CP_BSM 204 requests access to a mutual exclusion (mutex) lock at the context manager 132. At bock 420, if the mutex lock is available, the context manager 132 grants the CP_BSM 204 access to the mutex lock. Otherwise, the CP_BSM 204 waits until the mutex lock becomes available. At block 422, after the CP_BSM 204 obtains the lock, the CP_BSM 204 sends a request to the context manager 132 for a new context. In at least some implementations, the CP_BSM 204 sends, as part of the request, information such as a task identifier (e.g., a hash-based identifier or another type of identifier) that uniquely identifies the task to be associated with the new context; information about the specific shaders or kernels to be executed, the data they will operate on, etc.; the hardware resources that the tasks associated with the new context will require; and the like.

At block 424, in response to the allocation request, the context manager 132 allocates the new context for the task associated with the allocation request and notifies the CP_BSM 204 when the new context is ready to use. For example, the context manager 132 (or another component of the GPU 104) reserves a portion of the GPU memory for the new context. This reserved portion of memory is where the state of all the registers 130 that are part of the context will be stored. This memory block, in at least some implementations, is allocated from a predefined memory pool that's reserved for context storage. The context manager 132 also assigns an identifier to the new context, which is to be used by the CP_BSM 204 and other components of the GPU 104 to refer to the new context. The context manager 132, in at least some implementations, also initializes the state of the context by, for example, writing default values to all the registers in the new context, marking the new context as uninitialized to indicate that the new context is ready to have a state loaded into it, or the like.

The context manager 132 also provides information associated with the new context. For example, the context manager 132 provides a context identifier, context state information, context location information, and the like to the CP_BSM 204. The context identifier, in at least some implementations, is a hash-based identifier or another type of identifier that uniquely identifies the new context and allows the CP_BSM 204 and other components of the GPU 104 to distinguish between different contexts. The context state includes information relating to the state of the new context at the time of allocation since the new context inherits a default state from the GPU's initial state. For example, the context state includes the values of all the relevant registers at the point of allocation, context-specific settings and data that affect how commands are executed within this new context, and the like. The context location information includes, for example, an address or range of addresses where the new context is stored. In at least some implementations, the context manager 132 (or the CP_BSM 204) maintains a “last context” identifier that identifies the context that was the previous current context, i.e., the current context prior to allocation of the new context, and a “current context” identifier that identifies the context is currently being used for state updates and draws until the next clean to dirty state flag transition. Also, in at least some implementations, transfers the context, which was the current context prior to the allocation of the new context, to the register(s) 130 designated for the “last context” and also transfers the new context to the registers(s) 130 associated with the “current context”.

At block 426, after the CP_BSM 204 receives the notification from the context manager 132 that the new context has been allocated, the CP_BSM 204 releases the lock. At block 428, the CP_BSM 204 sends the command(s) 208-1 it was holding while the new context was being allocated to the GRBM 128. For example, the CP_BSM 204 sends one or more of the first state update packet 302, the second state updated packet 304, or the third state updated packet 306 to the GRBM 128. At block 430, the GRBM 128 receives and executes the command(s) 208-1 by writing the new values indicated in the command(s) 208-1 to the relevant registers 130 associated with the new context, which is now the current context.

At block 432, the CP_BSM 204 continues to monitor the output command stream 208 from the graphics register queue 202 and detects a set of draw commands generated or decoded by the processing unit 124 for the first draw packet 308. In at least some implementations, the CP_BSM 204 detects a set of draw commands (e.g., commands that configure the graphics pipeline 120 for the drawing operation) by monitoring for a write to a register that triggers execution of a draw call packet. Similar to detecting a context register write, the CP_BSM 204 can detect a write to a draw register based on the address indicated in the write command. At block 434, in response to detecting the set of draw commands, the CP_BSM 204 sets the graphics context flag 320-1 to the “clean” state, which indicates that the state of the current graphics context cannot be changed without performing an operation, such as sending either a Context Done event or a Block Context Done event down the graphics pipeline 120, to trigger the current context to finish. In at least some implementations, the CP_BSM also sets the graphics persistent state flag 320-2 to the “clean” state.

At block 436, the CP_BSM 204 sends the set of draw commands to the GRBM 128. At block 438, the GRBM 128 writes the set of draw commands to different registers or memory locations that correspond to the various functional units in the graphics pipeline 120. The registers send the received commands to the graphics pipeline 120, and the functional units interpret these commands, which include, for example, information such as what primitives to draw, their attributes, and where the required data is stored in memory. The functional units in the graphics pipeline 120 execute a first draw operation based on these instructions, accessing data from the memory and processing the data to create the final rendered output.

At block 440, the processing unit 124 receives another set of command packets 206, including, for example, the fourth state update packet 310, the fifth state update packet 312, and the second draw call packet 314. As described above with respect to block 404, the processing unit 124 interprets these packets and generates commands based on their contents. At block 442, after the processing unit 124 has generated the corresponding commands, the processing unit 124 pipelines another set of commands in the graphics register queue 202. It should be understood that FIG. 6 shows the processing unit 124 receiving the other set of command packets 206 and placing the other set of commands in the graphics register queue 202 after the draw operation has been performed for illustration purposes only. The processing unit 124 is able to perform these operations at any point in time and in parallel with any of the operations described above. For example, the processing unit 124 can place the other set of commands in the graphics register queue 202 along with the previous set of commands. Stated differently, the processing unit 124 continually pipelines commands into the graphics register queue 202 in a context-unaware manner.

At block 444, the graphics register queue 202 inserts the commands received from the processing unit 124 into the output command stream 208. At block 446, the CP_BSM 204 continues to snoop (e.g., monitor) the command stream 208 to detect specific commands. At block 448, if the CP_BSM 204 detects a command 208-2 in the command stream 208 that is not of a command type being monitored for, the CP_BSM 204 allows the command 208-2 to pass through to the GRBM 128 for processing. At block 450, the CP_BSM 204 subsequently detects one or more specified graphics commands. In this example, the CP_BSM 204 detects another context state update command, such as another context register write command, associated with at least one of the fourth state updated packet 310 or the fifth state update packet 312. As described above, the CP_BSM 204, in at least some implementations, detects a context register write based on the register address associated with the context register write.

At block 452, in response to detecting the context register write command(s), the CP_BSM 204 checks the state of the context flag(s) 320, such as the graphics context flag 320-1. As described above with respect to block 414, if the graphics context flag 320-1 is in a “dirty” state, a current context is not in use and the current context can be updated. However, if the graphics context flag 320-1 is in a “clean” state, this indicates that a previous draw command(s) (e.g., the first set of draw commands) was detected and a draw operation is using the current context. Stated differently, the current context cannot be updated until it is released. At block 454, the CP_BSM 204 determines that the graphics context flag is set to the “clean” state since a draw command was previously detected at block 434.

The CP_BSM 204, in response to determining that the graphics context flag is set to the “clean” state, initiates a context roll process 403 that is performed at blocks 456 to 474. At block 456, the CP_BSM 204 requests access to a mutex lock at the context manager 132. At block 458, if the mutex lock is available, the context manager 132 grants the CP_BSM 204 access to the mutex lock. Otherwise, the CP_BSM 204 waits until the mutex lock becomes available. At block 460, after (or before) the CP_BSM 204 obtains the lock, the CP_BSM 204 signals the context manager 132 with a Context Done event and the current context. For example, the CP_BSM 204 sends a notification, which includes the context identifier of the current context, to the context manager 132, indicating that CP_BSM 204 is issuing a Context Done event for the context associated with the content identifier. At block 462, in response to receiving the notification, the context manager 132 marks the current context as being associated with a Context Done event. In at least some implementations, the context manager 132 increments a counter indicating that there is a context done event outstanding. Further, in at least some implementations, a context is only allowed to recycle when there are no pending context done events in the graphics pipeline.

At block 464, the CP_BSM 204 also inserts a Context Done event into the command stream 208 and sends the command stream 208 to the GRBM 128. The Context Done event is inserted into the command stream 208 to release the current context and to act as a marker for the components in the graphics pipeline 120, indicating that the context is going to change after the draw operation. The Context Done event helps synchronize the various components of the graphics pipeline 120 to ensure that they all transition to the new context at the same time. At block 466, as part of the context roll process, the CP_BSM 204 also sends a request to the context manager 132 for a new context, similar to the process described above with respect to block 422. At block 468, the context manager 132 receives this request and allocates a new context, similar to the process described above with respect to block 424. In at least some implementations, the context manager 132 waits until the components of the graphics pipeline 120 have completed their operations associated with the current task (e.g., the first draw operation) in response to the Context Done event. In other implementations, the CP_BSM 204 does not send the new context allocation request to the context manager 132 until the components of the graphics pipeline 120 have completed their operations in response to the Context Done event. In at least some implementations, when the context manager 132 receives a signal from the graphics pipeline 120 indicating that the Context Done event has been handled, the context manager 132 releases a context to be reused for satisfying the context request from the CP_BSM 204.

At block 470, when the new context is allocated, the CP_BSM 204 (or another component of the GPU 104) transfers, via the GRBM 128, the context, which was the current context prior to the allocation of the new context, to the register(s) 130 designated for the “last context” and also transfers the new context to the registers(s) 130 associated with the “current context”. In at least some implementations, a context identifier is also stored with the transferred register state or maintained by the context manager 132, which identifies the previous context associated with the transferred register state. In at least some implementations, the CP_BSM 204 also issues a COPY_STATE register transaction indicating a destination address corresponding to the register(s) 130 associated with the current context and a source address corresponding to the register(s) 130 associated with the last context. The COPY_STATE register transaction indicates that all context state data is to be copied from the source location to the destination location in the graphics pipeline 120.

At block 472, the CP_BSM 204 marks the graphics context flag 320-1 as “dirty”, which allows the current context to be updated until a subsequent draw command is detected. At block 474, the CP_BSM 204 then releases the lock. As such, in at least some implementations, the CP_BSM 204 is configured to selectively perform the context roll process 403 based on the state of the graphics context flag 320-1 for switching from a current graphics context to a new graphics context having a context state based on the context state update command.

At block 476, the CP_BSM 204 sends the command(s) 208-1 it was holding while the context roll process was being performed to the GRBM 128. For example, the CP_BSM 204 sends one or more of the fourth state update packet 310 or the fifth state update packet 312 to the GRBM 128. At block 478, the GRBM 128 receives and executes the command(s) 208-1 by writing the new values indicated in the command(s) 208-1 to the relevant registers 130 associated with the current context. At block 480, the CP_BSM 204 continues to monitor the output command stream 208 from the graphics register queue 202 and detects another set of draw commands generated or decoded by the processing unit 124 for the second draw packet 314, as described above with respect to block 432. At block 482, the CP_BSM 204 sends the other set of draw commands to the GRBM 128. At block 484, the GRBM 128 writes the other set of draw commands to different registers or memory locations that correspond to the various functional units in the graphics pipeline 120. The functional units in the graphics pipeline 120 execute a second draw operation based on these commands or instructions, accessing data from the memory and processing the data to create the final rendered output. The process returns to block 440, where the processing unit 124 continues to pipeline graphics commands into the graphics register queue 202 and the processes described above with respect to blocks 442 to 474 are repeated.

As described above, the CP_BSM 204 not only performs graphics context management operations but also performs graphics persistent state management operations. For example, as part of method 400, in addition to monitoring for a context register write at block 412 of FIG. 4 or block 450 of FIG. 7, or monitoring for a draw register write at block 432 of FIG. 6 or block 480 of FIG. 9, the CP_BSM 204 also monitors for and detects persistent state register writes when snooping the command stream 208 at block 408 of FIG. 4 or block 446 of FIG. 7. For example, the CP_BSM 204 compares the register addresses associated with the commands to the graphics persistent state aperture, which includes dedicated ranges of memory addresses that are each associated with a register 130 for a specified persistent state 318 on the GPU 104. Stated differently, the persistent state aperture is associated with a specified command type (e.g., a persistent state register write command) that writes to the registers 130 in the range of address covered by the aperture, and the graphics context and persistent state apertures are associated with a different graphics command type. If the register address included in the command matches a register address in the graphics persistent state aperture, the CP_BSM 204 determines that the command is a persistent state register write.

In response to detecting the persistent state register write, the CP_BSM 204 checks the state of the graphics persistent state flag 320-2. If the graphics persistent state flag 320-2 has a “dirty” state, the persistent state is able to be changed without sending an event, such as a Block Context Done, to the graphics pipeline 120. The CP_BSM 204 then performs operations similar to those described above with respect to block 428. For example, the CP_BSM 204 sends the persistent state update commands to the GRBM. The GRBM receives and executes persistent state update commands by writing the new values indicated in the commands to the relevant registers 130 associated with the persistent state 318.

If the graphics persistent state flag 320-2 has a “clean” state, this indicates that a draw operation is currently being performed and the persistent state cannot be changed until the draw operation completes or is halted. Therefore, in at least some implementations, when the persistent state flag 320-2 has a “clean” state, the CP_BSM 204 inserts a Block Context Done event into the command stream 208 and sends the command stream 208 to the GRBM 128, similar to the process described above with respect to block 464 of FIG. 8. The Block Context Done event is inserted into the command stream 208 to synchronize and inform the various components/blocks of the graphics pipeline 120, such as the GE and SPI, that the persistent state will change so that the components complete their current operations. The CP_BSM 204 also sets the state of the graphics persistent state flag 320-2 to “dirty”, which allows the persistent state 318 to be updated until a subsequent draw command is detected.

In at least some implementations, components, such as the SPI (not shown), of the graphics pipeline 120, in at least some implementations, implement multiple shaders, such as a pixel shader, a geometry shader, a hull shader, and the like. Each of these shaders implements a queue, such as First-in, First-Out (FIFO) queue, to queue up Block Context Done events. In conventional configurations, when the SPI receives a Block Context Done event, the Block Context Done is placed in the queue of each shader regardless of the shader the Block Context Done is meant for. As such, in at least some implementations, the CP_BSM 204 addresses a Block Context Done to the intended shader of the SPI so that the Block Context Done is only placed in the queue for the intended shader(s). For example, when the CP_BSM 204 detects a persistent state update command having a register addresses corresponding to a specified shader of the SPI, the CP_BSM 204 inserts a Block Context Done event into the command stream 208 and sets a value in a specified field of a register accessible by the SPI. The value indicates which of the shaders the Block Context Done event is addressed to. When the SPI receives the Block Context Done event, the SPI decodes the Block Context Done to determine the value in the specified field of the register. Then, based on the value, the SPI places the Block Context Done event into the queue of the shader mapped to the value.

In at least some implementations, the command packets 206 generated and pipelined into the graphics register queue 202 by the processing unit 124 include an indicator, such as values or bits, that triggers or forces the CP_BSM 204 to perform one or more operations independent of whether the command is a context register write, a persistent state register write, a draw register write, or the like. For example, the processing unit 124 adds or changes bits in a field of the command, such as the payload field, that triggers the CP_BSM 204 to perform a context roll operation, a Block Context Done event insertion operation, a context release event insertion operation, a Push Current Context operation, a pop current context operation, and the like. In at least some implementations, when the CP_BSM 204 monitors the output command stream 208 at, for example, block 408 of FIG. 4 or block 446 of FIG. 7, the CP_BSM 204 checks the payload field of the commands 206 in the command stream 208 to determine if the bit(s) indicates that one of these operations is to be performed. If so, the CP_BSM 204 performs the operations associated with the identified bit(s).

When the CP_BSM 204 determines that the payload field includes a bit(s) to trigger a context roll operation, the CP_BSM 204 determines if a current context is allocated. If so, the CP_BSM 204 determines performs the context roll process 403 described above with respect to blocks 418 to 426 of FIG. 5. If the payload field includes a bit(s) to trigger with a Block Context Done operation, the CP_BSM 204 checks the persistent state context flag 320-2. If the persistent state context flag 320-2 has a “dirty” state, the CP_BSM 204 does not perform the Block Context Done operation. However, if the persistent state context flag 320-2 has a “clean” state, the CP_BSM 204 inserts a Block Context Done event into the command stream 208 for the current context, as described above, and then sets the persistent state context flag 320-2 to the “dirty” state. When the CP_BSM 204 determines that the payload field includes a bit(s) to trigger a context release operation, the CP_BSM 204 determines if a current context is allocated. If a current context is not allocated (unallocated), the CP_BSM 204 does not perform the context release operation. However, if a current context is allocated, the CP_BSM 204 inserts a Context Done event into the command stream 208 for the current context, as described above with respect to block 464 of FIG. 8. When the CP_BSM 204 determines that the payload field includes a bit(s) to trigger a push context release operation, the CP_BSM 204 performs a process similar to the context allocation process 401 described above with respect to blocks 418 to 426 of FIG. 5. For example, the CP_BSM 204 requests access to a mutex lock at the context manager 132. If the mutex lock is available, the context manager 132 grants the CP_BSM 204 access to the mutex lock. Otherwise, the CP_BSM 204 waits until the mutex lock becomes available. After the CP_BSM 204 obtains the lock, the CP_BSM 204 sends a request to the context manager 132 for a new context. In response to the allocation request, the context manager 132 allocates the new context. The CP_BSM 204 issues a copy state command on the new context, which saves the prior context as the pushed context. The CP_BSM 204 then releases the lock. When the CP_BSM 204 determines that the payload field includes a bit(s) to trigger a pop current context operation, the CP_BSM 204 inserts a Context Done event into the command stream 208 for the current context, as described above with respect to block 464 of FIG. 8. The CP_BSM 204 then sets the current context to the pushed context and updates an identifier that identifies the last context.

In at least some implementations, pipelined state manager 136 implements hardware-generated context hashing. For example, the CP_BSM 204 tracks the write commands in the command stream 208 output by the graphics register queue 202. Based on this tracking, the CP_BSM 204 generates a scoreboard of hash values for each context roll request and automatically queries the context manager 132 with the calculated hash between draws, assuming context writes occur. The context manager 132 then scans the provided hash against the current set of available contexts 216 using the identifier table 134. If there is a match, the context manager 132 returns the matching context. If there is a miss, the context manager 132 will allocate a new context and assign the provided hash with the new context. This mode, in some instances, may create situations where there are multiple Context Done events sent for a given context. In these situations, the context manager 132 tracks Context Done events for each context and only releases the context when the total number of Content Done events that have been sent is zero.

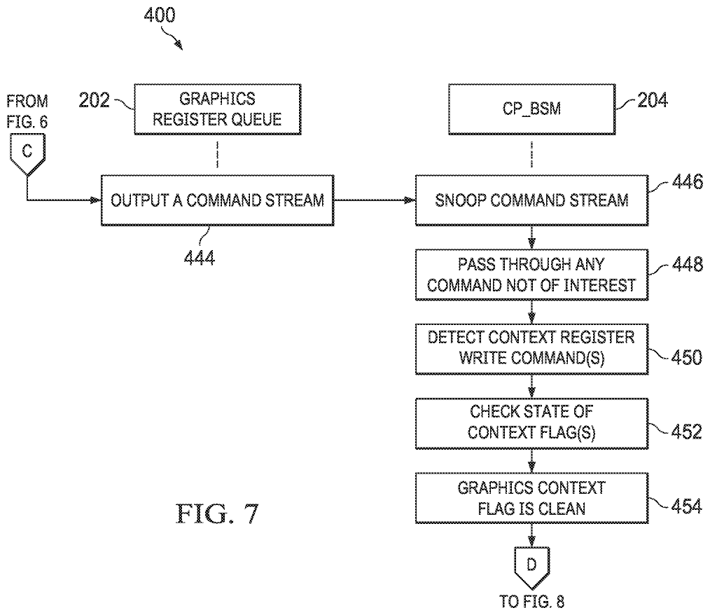

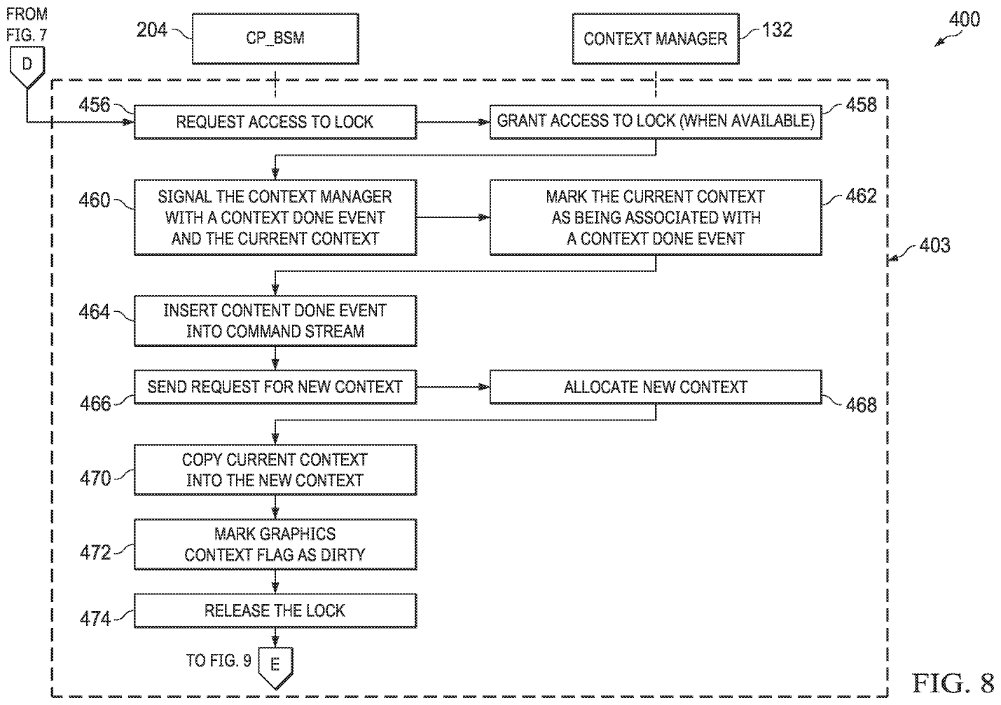

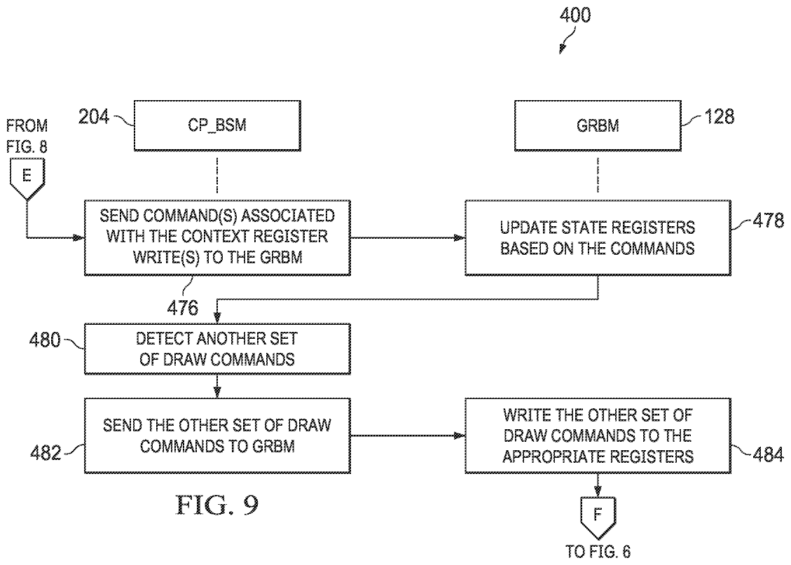

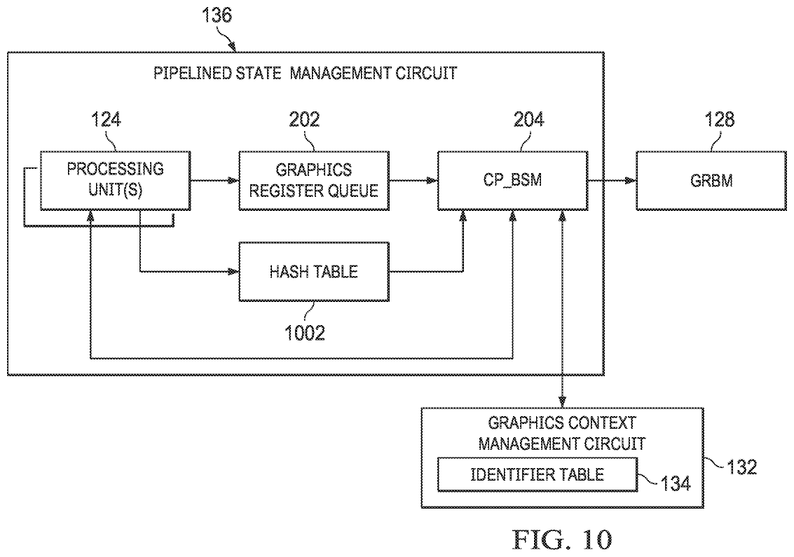

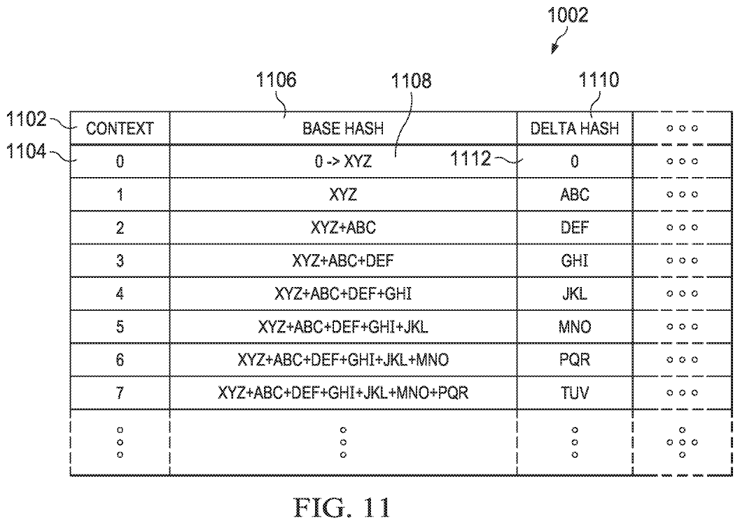

As such, to avoid multiple Context Done events being sent for a given context, the pipelined state manager 136 maintains a data structure, such as a hash table 1002, as shown in FIG. 10. For example, the pipelined state manager 136 maintains, for every context, the base hash used to initialize the context in the hash queue 1002 and also maintains a delta hash in the hash queue 1002 that tracks the context state changes done incrementally. FIG. 11 shows one example configuration of the hash table 1002. In this example, the hash table 1002 includes a first column 1102 that includes context identifiers 1104 for each context, a second column 1106 that includes the base hash 1108 used to initialize the context, and a third column 1110 that includes the delta hash 1112 for the context. When the processing unit 124 allocates a new context, the CP_BSM 204 (or another component) clears (e.g., zeroes out) both the base hash 1108 and the delta hashes 1112 in the hash queue 1002. In at least some implementations, the CP_BSM 204 initializes the base hash 1108 after the hash is calculated between the initial sequence of context register state updates and the first COPY_STATE write. However, in other implementations, the CP_BSM 204 initializes the base hash 1108 at a different point in time.

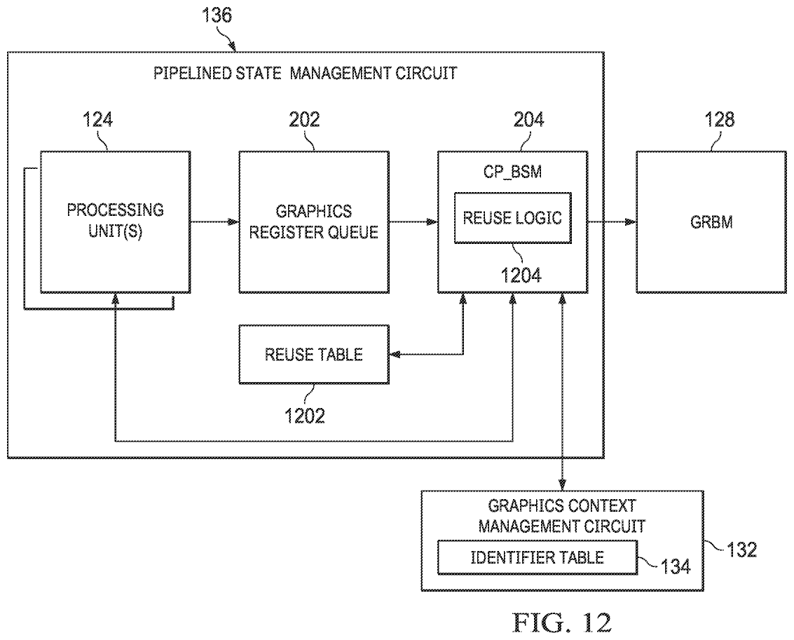

In some instances, there are situations when several draw operations use the same context programming but are not adjacent to each other. In these situations, the command processor 122 may end up rolling contexts in between those draw operations. As such, the pipelined state manager 136, in at least some implementations, employs one or more context reuse mechanisms to use a context from a previous draw operation that had the same programming as the current draw operations. For example, as shown in FIG. 12, the command processor 122 maintains a context reuse table 1202 (also referred to herein as “table 1202”) of register addresses and values for all contexts 216. In at least some implementations, a subset of the available context registers 130, such as the top-most N frequently programmed registers 130, are stored in the table 1202. The register addresses that are to be stored in the table 1202, in at least some implementations, are provided to the command processor 122 by the user mode driver 116 (or another GPU driver). Any context register changes outside this list force the CP_BSM 204 to retire all the previous contexts 216.

When the command processor 122 comes out of a reset process, the CP_BSM 204 is informed by the user mode driver 116 to populate the register address for all the slots in the table 1202 using a specified register value size (e.g., a 12-bit register value). In at least some implementations, the register addresses can be changed after a wait for idle. The CP_BSM 204 implements context reuse logic 1204 that maintains a valid bit and a Context Done (CD) counter (e.g., an 8-bit counter) for every context column in the table 1202. Both the valid bit and the CD counter are set to 0 on reset. A context is available for programming when the CD count is 0.

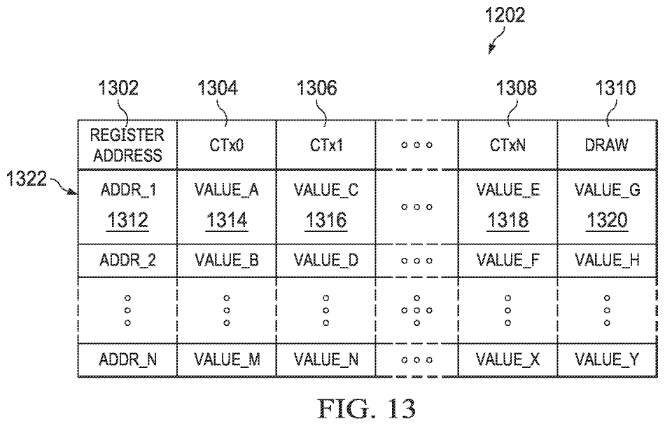

In at least some implementations, each context column of the table 1202 stores the programming for a context. An additional column is used to store the programming for the incoming draw operation. This way, any change in context is captured immediately. For example, FIG. 13 shows one example of the context reuse table 1202. In this example, the table 1202 includes a register address column 1302, a plurality of context columns 1304 to 1308 (e.g., one column for each of the contexts 216 available at the GPU 104), and an incoming draw operation column 1310 (also referred to herein as “current context columns 1310). The register address column 1302 includes entries 1312 identifying the register address of the register 130 associated with the row 1318. Each context column 1304 to 1308 includes an entry 1314 to 1318 having the state (e.g., value) of the register 130 for the context associated with the column. For example, the first context column 1304 includes an entry 1314 indicating that the register 130 having address ADDR_1 has a value of VALUE_A for context CTx0. The incoming draw operation column 1310 includes entries 1320 having the state (e.g., value) of the register 130 for the incoming draw operation associate. For example, the incoming draw operation column 1310 includes an entry 1320 indicating that the register 130 at address ADDR_1 has a value of VALUE G for the incoming draw operation.

The CP_BSM 204 writes the first set of values after reset for the first context in the table 1202 for the corresponding register addresses. When the CP_BSM 204 marks the context clean (e.g., sets the state of the graphics context flag 320-1 to “clean”), the CP_BSM 204 sends the context ID to the reuse logic 1204. The reuse logic 1204 uses the context ID as a tag for the first column in the table 1202. The reuse logic 1204 then sets the valid bit to 1 and the CD counter to 0 for the column. In at least some implementations, the command processor 122 implements two bit masks (e.g., two 8-bit masks) to maintain the previous context match and new context match. The command processor 122 also implements a global valid bit that, when set to 0, invalidates context reuse for the current and all the future draws.

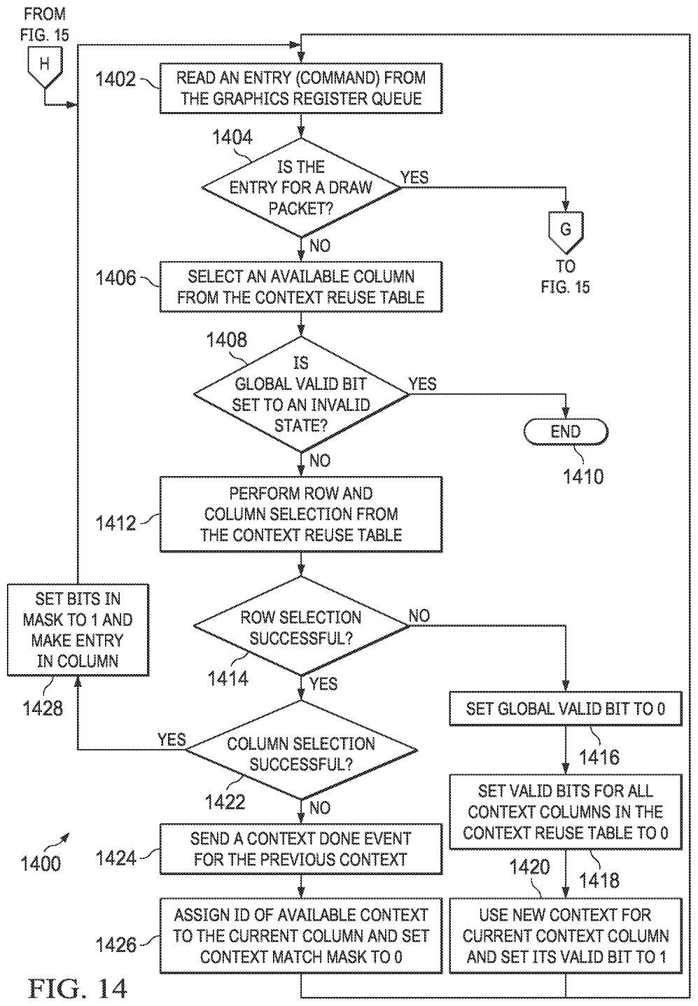

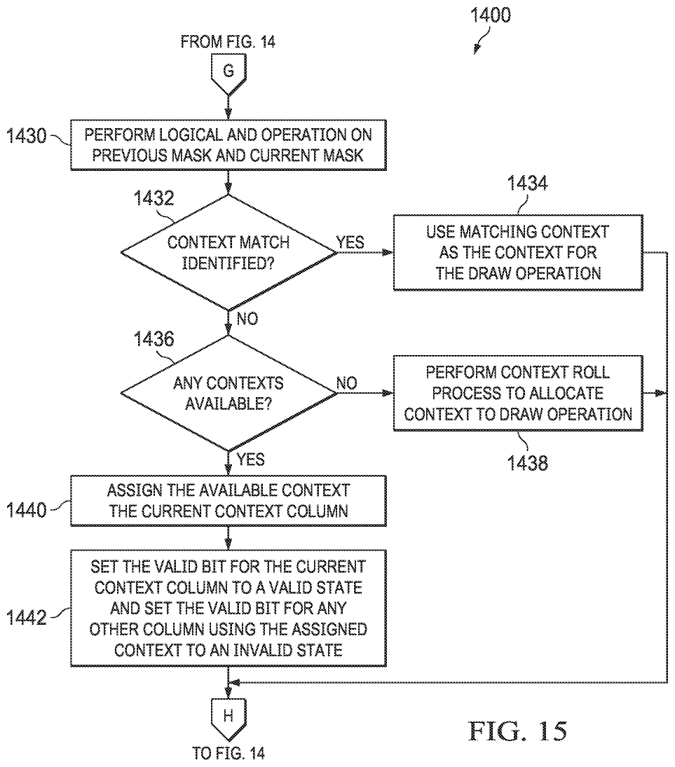

FIG. 14 is a diagram illustrating an example method 1400 of performing context reuse using the context reuse table 1202 in accordance with at least some implementations. For purposes of description, the method 1400 is described with respect to an example implementation at the processing system 100 of FIG. 1, but it will be appreciated that, in other implementations, the method 1400 is implemented at processing devices having different configurations. Also, the method 1400 is not limited to the sequence of operations shown in FIG. 14, as at least some of the operations can be performed in parallel or in a different sequence. Moreover, in at least some implementations, the method 1400 can include one or more different operations than those shown in FIG. 14.

At block 1402, the CP_BSM 204 reads an entry (command) from the graphics register queue 202. At block 1404, the context reuse logic 1204 determines if the entry is for a draw command. If so, the process flows to block 1430 of FIG. 15 Otherwise, at block 1406, the context reuse logic 1204 determines the command is for a context register write and selects one of the available context columns in the table 1202. At block 1408, the context reuse logic 1204 checks the global valid bit. If the global valid bit is set to an invalid state (e.g., “0”), the process ends at block 1410, and context reuse is not performed. At block 1412, if the global valid bit is set to a valid state (e.g., “1”), the context reuse logic 1204 performs a row selection process in the table 1202 using the register address from the command in the entry read from the graphics register queue 202 and performs a column selection process from the rest of the table 1202 by looking for a match in all the context columns that are valid in the table 1202. In at least some implementations, the context reuse logic 1204 determines if a context column is valid based on the valid bit associated therewith.

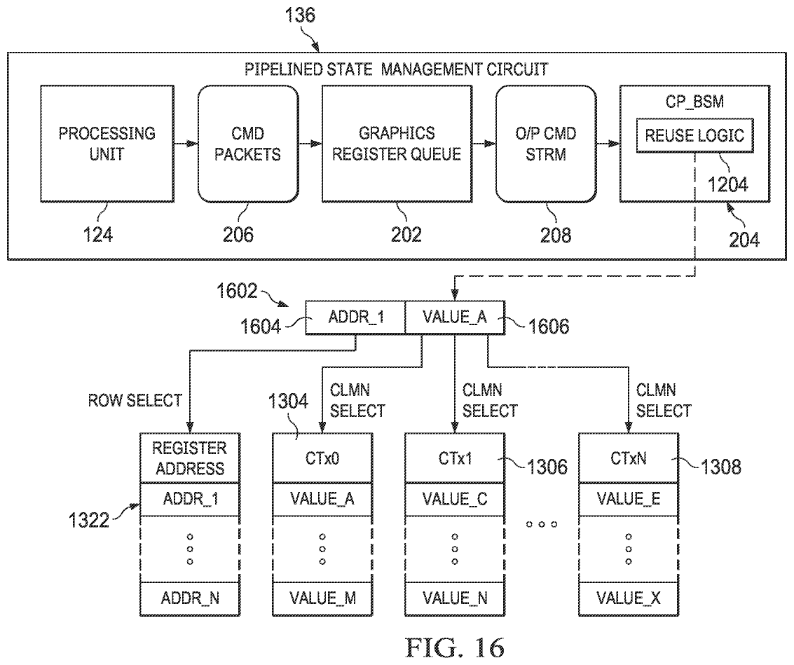

For example, FIG. 16 shows an example of the CP_BSM 204 reading a context register command 1602 from the output command stream 208 of the graphics register queue 202. The context register command 1602 includes a register address value 1604 of ADDR 1 and a context state value 1606 of VALUE_A to be programmed into the register having address ADDR_1. In this example, the global value bit is set to the valid state, so the context reuse logic 1204 performs one or more context reuse operations. As such, the context reuse logic 1204 searches the table 1202 for a row having an entry under the Register Address column 1302 corresponding to the register address ADDR_1 in the context register write command 1602. The context reuse logic 1204 also parses each context column 1304 to 1308 to identify any context column having a context state value matching the context state value of VALUE_A included in the context register write command 1602.

Referring again to FIG. 14, at block 1414, the context reuse logic 1204 determines if the row selection process was successful. For example, the context reuse logic 1204 determines if any rows 1322 were identified in the table 1202 that include the register address (e.g., ADDR_1) from the context register command. At block 1416, if the row selection process failed (e.g., no rows include a matching register address), the context reuse logic 1204 sets the global valid to 0, which invalidates the table 1202. This implies that a register outside the table 1202 is changing. Therefore, previous register programming cannot be trusted for reuse. At block 1418, the context reuse logic 1204 also sets the valid bits for all the context columns in the table to 0. At block 1420, the CP_BSM 204 uses a new context for the current context column, and the valid bit is set to 1. For example, if there are eight contexts available in the GPU 104, the table 1202 includes eight columns corresponding to the eight available contexts and one extra column for the current context. If the context reuse logic 1204 detects a difference in programming compared to the previously allocated columns, the context reuse logic 1204 assigns an available context ID to the current context column and invalidates any other column that is using this context ID. The CP_BSM 204 uses the invalidated column to process the next draw. The process then returns to block 1402.

At block 1422, if the row selection process passed (e.g., a row includes a matching register address), the context reuse logic 1204 determines if the column select process was successful, e.g., a column has an entry with a context state value matching the context state value of the context register command that is in a row that has a register address matching the register address of the context register command. In the example shown in FIG. 16, the context reuse logic 1204 determines that a row 1322 in the table 1202 includes the register address ADDR_1, which matches the register address value 1604 in the context register command 1602. Therefore, the context reuse logic 1204 determines that the row selection process was successful. In response, the context reuse logic 1204 determines if any of the context columns in the table 1202 include a context state value (in the matching row) that matches the context state value 1606 (e.g., VALUE_A) in the context register command 1602.

Referring again to FIG. 14, at block 1424, if the context reuse logic 1204 determines the column selection process was unsuccessful, the CP_BSM 204 sends a Context Done event for the previous context. At block 1426, the CP_BSM 204 assigns the context ID of an available context to the current context column and sets the context match mask to 0. If a context is not available, the CP_BSM 204 waits for a context to become available to perform the operations at block 1424. The process then returns to block 1402.

At block 1428, if the context reuse logic 1204 determines the column select process was successful, the context reuse logic 1204 sets the bits in the context match mask to 1 and makes an entry into the unused column (e.g., the current context column) at the right row, which is identified based on the register address. The process then returns to block 1402. The context reuse logic 1204, in at least some implementations, determines that the column select process was successful in response to a context column in the table 1202 having a context state value (within the row having a matching register address) that matches the context state value in the context register command. For example, in FIG. 16, the context column for context CTx0 includes a context state value (VALUE_A) that matches the context state value (VALUE_A) of the context register command 1602 and that is in the row 1322 having a matching register address (ADDR_1).

As indicated above, at block 1404, if the context reuse logic 1204 reads an entry from the graphics register queue 202 for a draw operation, the process flows to block 1430. At block 1430, the context reuse logic 1204 performs a logical AND operation on the previous context match mask and the current context match mask to find context hits. At block 1432, the context reuse logic 1204 determines if a context match was identified. At block 1434, if a context match is identified, the matching context is used for the draw operation, and the context reuse logic 1204 does not set the valid bit for the current context column. In at least some implementations, a column is matched (selected) when the entire programming for the draw matches at least one previous context. The valid bit is not set for the current context column because a different column, i.e., the column that matched, is being reused. If multiple matches are found, the context reuse logic 1204 selects the first match, randomly selects one of the matches, or the like. As such, instead of allocating a new context or potentially waiting for a context to free up (thereby resulting in a graphics pipeline stall), the reuse logic 1204 performs context bouncing by switching back to an existing, matching context that is already available at the GPU 104 without allocating a new context for the draw operation. The process then returns to block 1402.

At block 1436, if a match was not identified based on ANDing the previous context match mask and the current context match mask, the context reuse logic 1204 further determines if there are any contexts available (i.e., the context is not being used by any draw operations). At block 1438, if a context is not available, the CP_BSM 204 performs the context roll process 403 described above to allocate a context to the draw operation. The process then returns to block 1402. At block 1440, if a context is available, the context reuse logic 1204 assigns the current context column in the table 1202 the available context. In at least some implementations, the available context is assigned by using the context ID of the context as a tag for the current context column. At block 1442, the context reuse logic 1204 sets the valid bit for the current context column valid state and sets the valid bit for any other column using the assigned context to an invalid state. The process then returns to block 1402.

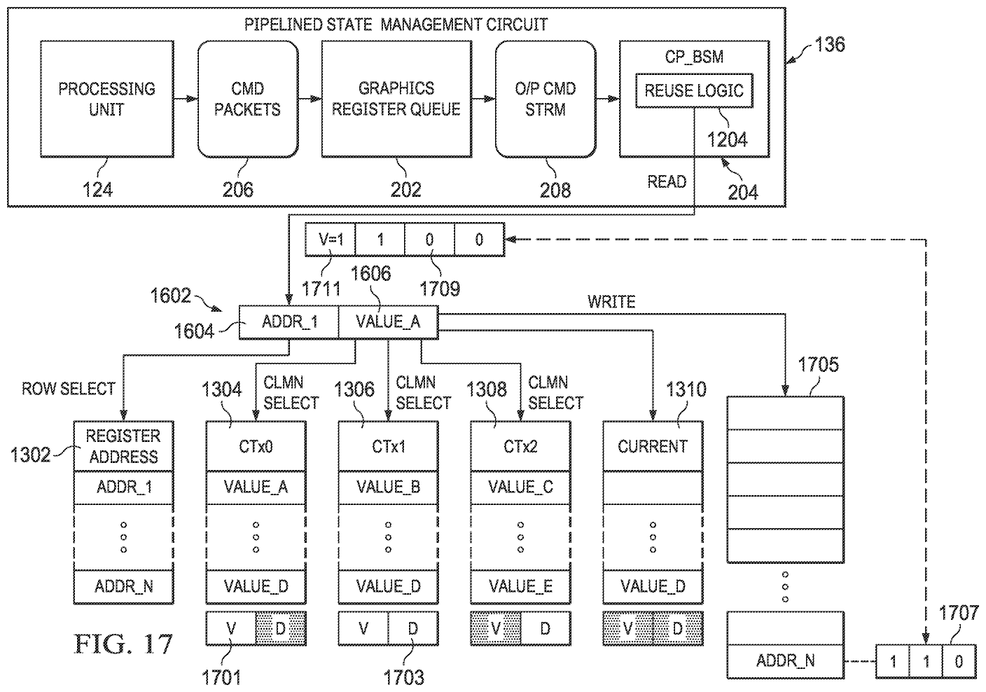

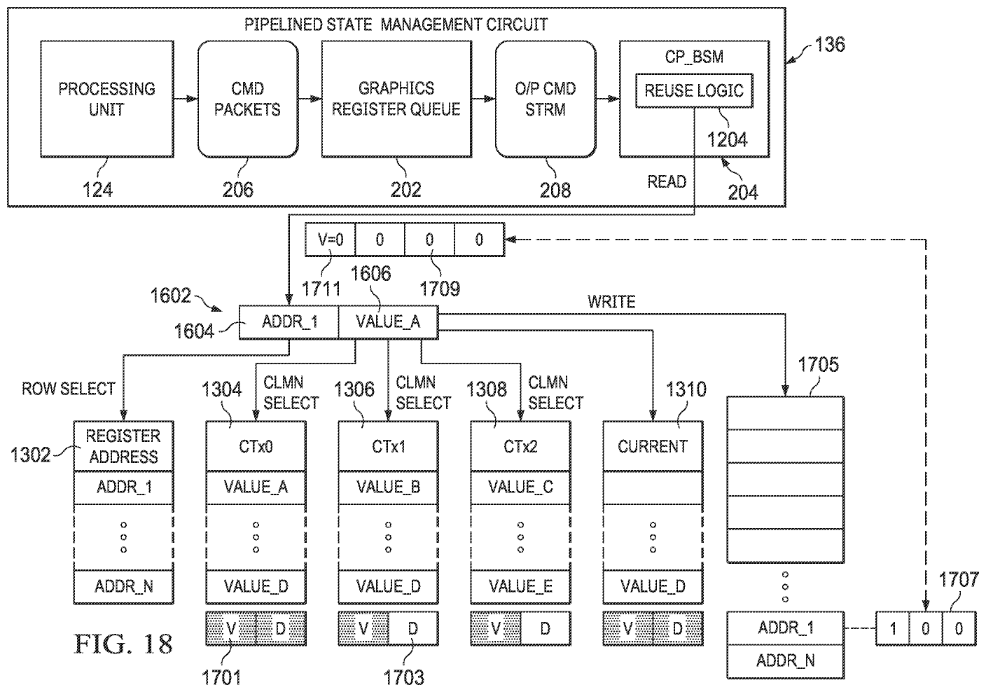

FIG. 17 and FIG. 18 show examples of the CP_BSM 204 performing the context reuse check described above with respect to FIG. 14 and FIG. 15. In these examples, FIG. 17 shows the state of the context reuse logic 1204 at clock n−1, and FIG. 18 shows the state of the context reuse logic 1204 at clock n. FIG. 17 and FIG. 18 further show examples of columns from the context reuse table 1202. In these examples, the columns include a register address column 1302 that is populated by the user mode driver 116, a first context column 1304 for a first context (CTx0), a second context column 1306 for a second context (CTx1), a third context column 1308 for a third context (CTx2), and a current context column 1310. Each cell in a context column stores the value assigned to the register on that context. For example, the first context column 1304 includes an entry storing the value VALUE_A for context CTx0 and register address ADDR_A and also includes an entry storing the value VALUE_D for context CTx0 and register address ADDR_N. The current context column 1310 stores the values for the incoming draw. For example, the current column 1310 in FIG. 17 and FIG. 18 includes an entry having a context value of VALUE 3 register address ADDR_N.

A valid bit 1701 and an active draw bit 1703 are associated with each of the columns 1304 to 1308. In FIG. 17 and FIG. 18, a valid bit 1701 indicating that a context is valid and available for reuse is represented as a shaded box, and a valid bit 1701 indicating that a context is not valid or available for reuse is represented as an unshaded box. Similarly, an active draw bit 1703 indicating that a draw is active on the context is represented as a shaded box, and an active draw bit 1703 bit indicating that an active draw is not active on the context is represented as an unshaded box. Therefore, in the example shown in FIG. 17 contexts CTx0, CTx1, and CTx2 are valid and ready for reuse and only contexts CTx1 and CTx2 have an active draw. In the example shown in FIG. 18, none of the contexts are valid and ready for reuse, and only contexts CTx1 and CTx2 have an active draw.

In at least some implementations, the context reuse logic 1204 stores the incoming register write commands in a buffer 1705. These incoming register write commands, in at least some implementations, are stored until the reuse check has been completed. If the reuse fails, all of the incoming register write commands are sent down the GRBM 128. However, if the reuse passes, the context reuse logic 1204 flushes the buffer 1705. The context reuse logic 1204, in at least some implementations, also maintains a previous context match mask 1707 and current context match mask 1709, as described above with respect to FIG. 12. In these masks, each bit corresponds to a context column, and the value of the bit indicates if a match in that context was identified or was not identified. In at least some implementations, a value of “0” indicates that a match for that context was not identified, and a value of “1” indicates that a match for that context was identified.

When the context reuse logic 1204 reads a register write command from the graphics register queue 202, the context reuse logic 1204 sets the bits in the current context match mask 1709 based on the results of the context reuse comparison process described above with respect to FIG. 14 and FIG. 15. When a register write command is stored in the buffer 1705, the previous context match mask 1707 is updated. When the context reuse logic 1204 reads a new register write command from the graphics register queue 202, if at least 1 bit in the previous context match mask 1707 is set to 1, the context reuse logic 1204 determines that context reuse can be performed. However, as described above with respect to FIG. 12, if the global valid bit 1711 is set to 0, context reuse for the current and all the future draws is invalidated.

For example, in FIG. 17, the previous register write command matched with contexts CTx0 and CTx1, and the incoming register write command matched only with context CTx0. Therefore, the bits for the previous context match mask 1707 are set to (110), and the bits for the current context match mask 1709 are set to (100). However, in FIG. 18, the previous register write command (i.e., the incoming register write command of FIG. 17) matched with context CTx0. Therefore, the bits of the previous context match mask 1707 are set to (100). However, because the incoming register write command does not match with any values in the register address column 1302, the bits of the current context match mask 1709 are set to (000), and all contexts are invalided (e.g., the global valid bit 1711 is set to 0).

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method, comprising:
placing, by a processing unit of a command processor of a graphics processing unit (GPU), a plurality of graphics commands into a queue;
monitoring, by a fixed-function hardware circuit, a graphics command stream output by the queue; and
performing, by the fixed-function hardware circuit responsive to detecting a specified graphics command in the monitored graphics command stream, at least one graphics command management operation including one or more of a graphics context management operation or a graphics persistent state management operation.

2. The method of claim 1, wherein the plurality of graphics commands include one or more of a graphics context state update command, a graphics persistent state update command, or a draw command, and wherein placing the plurality of graphics commands into the queue comprises placing the plurality of graphics commands into the queue independent of whether a graphics context is available for the plurality of graphics commands.

3. The method of claim 1, wherein the fixed-function hardware circuit is disposed between the queue and a graphics pipeline of the GPU.

4. The method of claim 1, wherein detecting the specified graphics command in the monitored graphics command stream comprises:
responsive to detecting a graphics command in the graphics command stream, comparing a register address included in the graphics command to a plurality of register apertures, wherein each register aperture of the plurality of register apertures is associated with a different graphics command type; and
responsive to the register address matching a register address in one register aperture of the plurality of register apertures, determining that the graphics command is a specified graphics command.

5. The method of claim 1, wherein performing the at least one graphics command management operation comprises:
responsive to determining that the specified graphics command is a graphics context state update command and a current graphics context is unallocated, performing a context allocation operation comprising:
requesting a new graphics context from a context management circuit;
updating the new graphics context based on the graphics context state update command; and
setting the updated new graphics context as the current graphics context.

6. The method of claim 5, wherein performing the context allocation operation further comprises:
obtaining a lock at the context management circuit prior to requesting the new graphics context; and
releasing the lock after the updated new graphics context is set as the current graphics context.

7. The method of claim 1, wherein performing the at least one graphics command management operation comprises:
responsive to determining that the specified graphics command is a graphics context state update command and a current graphics context is allocated to a draw operation, performing a context roll operation comprising:
inserting a marker into the graphics command stream indicating to components of a graphics pipeline of the GPU that a state of the current graphics context is to be updated.

8. The method of claim 7, wherein performing the context roll operation further comprises:
requesting a new graphics context from a context management circuit;
copying a state of the current graphics context to the new graphics context; and
updating a state of the current graphics context based on the graphics context state update command.

9. The method of claim 8, wherein determining that the current graphics context is allocated to the draw operation is in response to determining that a flag is set to a first state indicating that the state of the current graphics context is not updatable, and
wherein performing the context roll operation further comprises setting the flag to a second state in response to copying the state of the current graphics context to the new graphics context, wherein the second state indicates that the state of the current graphics context is updatable.

10. The method of claim 1, wherein performing the at least one graphics command management operation comprises:
responsive to determining that the specified graphics command is a graphics persistent state update command and a current graphics context is allocated to a draw operation:
inserting a marker into the graphics command stream indicating to components of a graphics pipeline of the GPU that a graphics persistent state is to be updated.

11. The method of claim 10, wherein determining that the current graphics context is allocated to the draw operation is in response to determining that a flag is set to a first state indicating that a state of the current graphics context is not updatable, and
wherein performing the at least one graphics command management operation further comprises setting the flag to a second state in response to inserting the marker, wherein the second state indicates that the graphics persistent state is updatable.

12. The method of claim 1, wherein performing the at least one graphics command management operation comprises:
responsive to determining that the specified graphics command is a draw command, setting one or more of a first flag to indicate that a current graphics context is allocated to a draw operation and is not updateable or a second flag indicating that a graphics persistent state is not updateable.

13. The method of claim 1, further comprising:
inserting, by the processing unit, an indicator into a field of at least one graphics command of the plurality of graphics commands, the indicator configured to force the fixed-function hardware circuit to perform one or more of a graphics context management operation or a graphics persistent state management operation.

14. A processor, comprising:
a plurality of state registers configured to maintain context states for a plurality of graphics contexts; and
a command processor, wherein the command processor comprises:
a processing unit configured to place a plurality of graphics commands into a queue; and
a fixed-function hardware circuit configured to:
monitor a graphics command stream output by the queue; and
detect a specified graphics command in the monitored graphics command stream; and
responsive to the detected specified graphics command, perform at least one graphics command management operation including one or more of a graphics context management operation or a graphics persistent state management operation.

15. The processor of claim 14, wherein the processing unit is configured to place the plurality of graphics commands into the queue independent of whether a graphics context is available for the plurality of graphics commands.

16. The processor of claim 14, wherein the fixed-function hardware circuit is configured to detect the specified graphics command in the monitored graphics command stream by:
comparing a register address included in the specified graphics command to a plurality of register apertures for the plurality of state registers responsive to detecting a graphics command in the graphics command stream, wherein each register aperture of the plurality of register apertures is associated with a different graphics command type; and
responsive to the register address matching a register address in one register aperture of the plurality of register apertures, determining that the graphics command is a specified graphics command.

17. The processor of claim 14, wherein the fixed-function hardware circuit is configured to perform the at least one graphics command management operation by:
responsive to determining that the specified graphics command is a graphics context state update command and a current graphics context of the plurality of graphics contexts is unallocated, performing a context allocation operation comprising:
requesting a new graphics context from a context management circuit;
updating the new graphics context based on the graphics context state update command; and
setting the updated new graphics context as the current graphics context.

18. The processor of claim 14, wherein the fixed-function hardware circuit is configured to perform the at least one graphics command management operation by:
responsive to determining that the specified graphics command is a graphics context state update command and a current graphics context of the plurality of graphics contexts is allocated to a draw operation, performing a context roll operation comprising:
inserting a marker into the graphics command stream indicating to components of a graphics pipeline that a state of the current graphics context is to be updated;
requesting a new graphics context from a context management circuit;
copying a state of the current graphics context to the new graphics context; and
updating a state of the current graphics context based on the graphics context state update command.

19. The processor of claim 14, wherein the processing unit is further configured to:
insert an indicator into a field at least one of graphics command of the plurality of graphics commands, the indicator configured to force the fixed-function hardware circuit to perform one or more of a graphics context management operation or a graphics persistent state management operation.

20. A processor, comprising:
a plurality of state registers configured to maintain context states for a plurality of graphics contexts; and
a command processor, wherein the command processor comprises:
a processing unit configured to place a plurality of graphics commands into a queue; and
a fixed-function hardware circuit configured to:
detect a context state update command in a graphics command stream output by the queue;
responsive to the detected context state update command, check a state of a flag associated with a graphics context state; and
responsive to the state of the flag, selectively performing a context roll process to switch from a current graphics context to a new graphics context having a context state based on the context state update command.
